(19) United States
(12) Patent Application Publication
(10) Pub. No.: US 2015/0306541 A1
(43) Pub. Date: Oct. 29, 2015

(54) METHODS FOR TREATING FURNACE OFFGAS

(71) Applicants: Joseph Naumovitz, Lebanon, NJ (US); Stevan Jovanovic, North Plainfield, NJ (US); Wei Wei, Sugar Land, TX (US)

(72) Inventors: Joseph Naumovitz, Lebanon, NJ (US); Stevan Jovanovic, North Plainfield, NJ (US); Wei Wei, Sugar Land, TX (US)

(21) Appl. No.: 14/662,548

(22) Filed: Mar. 19, 2015

Related U.S. Application Data
(60) Provisional application No. 61/968,424, filed on Mar. 21, 2014.

(51) Int. Cl. B01D 53/52; F27D 17/00; C21B 13/00; B01D 53/78; B01D 53/14

(52) U.S. Cl. CPC B01D 53/526; B01D 53/78; B01D 53/1493; C21B 13/00; F27D 17/00; B01D 2252/204

(57) ABSTRACT

A method is provided for separating hydrogen sulfide and carbon dioxide from an offgas stream from a direct reduced iron furnace. The offgas is directed to a separation device which will separate the carbon dioxide and hydrogen sulfide using a hydrogen sulfide absorber and a carbon dioxide absorber. The hydrogen sulfide can be recycled for reuse in the furnace and the carbon dioxide recovered for other additional uses.

### CROSS REFERENCE TO RELATED APPLICATIONS

This application claims priority from U.S. provisional application 61/968,424 filed Mar. 21, 2014.

### BACKGROUND OF THE INVENTION

The present invention provides for gas separation methods for use in iron reduction furnaces. More particularly, the invention provides for methods for separating carbon dioxide from hydrogen sulfide in the offgas from a Direct Reduced Iron (DRI) furnace.

The Direct Reduced Iron technique produces iron in a manner different from conventional blast furnaces. Direct Reduced Iron is produced from the direct reduction of iron ore in the form of lumps, pellets or fines by a reducing gas that is produced from natural gas or coal. The reducing gas is a mixture of hydrogen and carbon monoxide which acts as a reducing agent. These reducing gases will directly reduce the iron ore in solid form.

In current Direct Reduced Iron furnace technology, a process gas heater is used in the design of the furnace. A natural gas feed is directed to a partial oxidation furnace to produce the reducing gas mixture of hydrogen and carbon monoxide. A steady stream of hydrogen sulfide is fed to the natural gas stream and will upon entering the process gas heater assist in minimizing the formation of carbon metal dust.

Carbon dioxide which is also a byproduct of the partial oxidation reactor and the iron reducing process is recovered from the DRI furnace and is vented to the atmosphere. However, the offgas from the DRI furnace will also contain the hydrogen sulfide used to inhibit carbon metal dust formation. The presence of the hydrogen sulfide in the gas limits the amount that can be vented due to concerns over exceeding environmental sulfur limitations.

So in order for the operator to use the carbon dioxide by either venting or selling as a byproduct, the hydrogen sulfide present must be removed. This invention addresses this need for removal by separating the hydrogen sulfide from the carbon dioxide in the offgas from the DRI furnace in a separation device which will create a carbon dioxide stream free of hydrogen sulfide as well as a hydrogen sulfide stream for use in the DRI furnace process.

### SUMMARY OF THE INVENTION

In one embodiment of the invention there is disclosed a method for operating a direct reduced iron furnace wherein synthesis gas and hydrogen sulfide are fed to the direct reduced iron furnace, the improvement comprising separating carbon dioxide and hydrogen sulfide from offgas from the direct reduced iron furnace.

The carbon dioxide and the hydrogen sulfide are recovered. The recovered hydrogen sulfide is fed along with natural gas into a process gas heater.

The offgas is fed to a carbon dioxide separation device and a hydrogen sulfide separation device. The carbon dioxide and hydrogen sulfide are separated from the offgas by, a carbon dioxide absorber in fluid communication with a hydrogen sulfide absorber.

The hydrogen sulfide absorber contains an absorbent material comprising an amine compound. Likewise the carbon dioxide absorber contains an absorbent material comprising an amine compound.

A hydrogen sulfide stripper may additionally be in fluid communication with the hydrogen sulfide absorber.

In a second embodiment of the invention, there is disclosed a method for separating hydrogen sulfide and carbon dioxide from offgas from a direct reduced iron furnace comprising feeding the offgas to a separation device.

The separation device comprises a carbon dioxide separation device and a hydrogen sulfide separation device. The carbon dioxide separation device is a carbon dioxide absorber and the hydrogen sulfide separation device is a hydrogen sulfide absorber.

The carbon dioxide and the hydrogen sulfide are recovered and the recovered hydrogen sulfide is fed along with natural gas into a process gas heater.

The carbon dioxide separation device and the hydrogen sulfide separation device are in fluid communication with each other. The hydrogen sulfide absorber contains an absorbent material comprising an amine compound. Likewise the carbon dioxide absorber contains an absorbent material comprising an amine compound.

A hydrogen sulfide stripper may additionally be in fluid communication with the hydrogen sulfide absorber.

In another embodiment of the invention, there is disclosed a method for recycling hydrogen sulfide from a direct reduced iron furnace comprising the steps of a) recovering offgas comprising carbon dioxide and hydrogen sulfide from the direct reduced iron furnace; b) separating the carbon dioxide from the hydrogen sulfide; and c) feeding the hydrogen sulfide to the direct reduced iron furnace.

The offgas is fed to a carbon dioxide separation device and a hydrogen sulfide separation device. The carbon dioxide may be a carbon dioxide absorber which contains an absorbent material comprising an amine compound. The hydrogen sulfide separation device may be a hydrogen sulfide absorber which contains an absorbent material comprising an amine compound.

A hydrogen sulfide stripper may additionally be in fluid communication with the hydrogen sulfide absorber.

The offgas from the DRI furnace typically contains between 60 to 80% syngas, 10 to 15% carbon dioxide, less than 10% methane and 200 to 10,000 parts per million (ppm) of hydrogen sulfide. This offgas will typically be at an elevated pressure on the order of 100 to 200 psia.

In this invention, the gas separation device can comprise a carbon dioxide absorber in fluid communication with a hydrogen sulfide absorber which is in fluid communication with a hydrogen sulfide stripper.

Alternatively the gas separation device can comprise an amine absorber which will absorb carbon dioxide from the syngas and methane gas mixture and directs the carbon dioxide through a series of unit operations to produce a carbon dioxide product for reuse, venting or for resale. The hydrogen sulfide in the offgas can be separated by feeding the offgas to a hydrogen sulfide absorber which is in fluid communication with a hydrogen sulfide stripper which will separate out the hydrogen sulfide and return it to the DRI furnace system where it can be injected into the natural gas upstream of the process gas heater. In this embodiment, the carbon dioxide separation and hydrogen sulfide separation are distinct processes.

The benefits of the inventive separation scheme include reduced hydrogen sulfide usage due to recycle from the DRI furnace; reduced sulfur emissions to the atmosphere and/or elimination of a sulfur recovery plant and improved carbon dioxide purity for added byproduct value.

### BRIEF DESCRIPTION OF THE DRAWINGS

FIG. 1 is a schematic of a Direct Reduced Iron furnace with a carbon dioxide and hydrogen sulfide separation device.

FIG. 2 is a schematic of a carbon dioxide and hydrogen sulfide separation system.

FIG. 3 is a schematic of a carbon dioxide separation system.

### DETAILED DESCRIPTION OF THE INVENTION

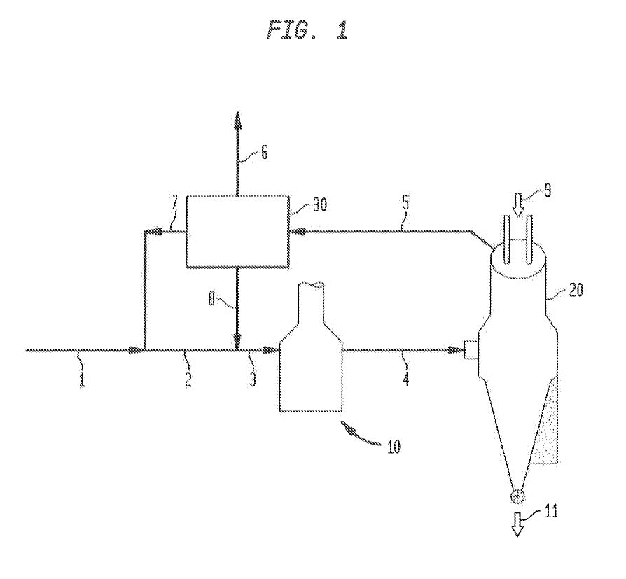

Referring to FIG. 1, a Direct Reduced Iron furnace is shown with a carbon dioxide and hydrogen sulfide separation system.

Natural gas 1 is mixed with recycled furnace offgas 7 and is sent to process gas heater 10. Prior to entering the process gas heater 10, a recycled hydrogen sulfide stream 8 is fed into the line directing the natural gas into the process gas heater. The hydrogen sulfide will inhibit the formation of metal dust which can be detrimental to the process gas heater operation.

The heated stream 4 enters the DRI furnace 20 along with an injected oxygen stream (not shown). In the bottom section of the DRI, a partial oxidation reaction converts the natural gas into carbon monoxide and hydrogen via the following reaction.

2CH₄+O₂→2CO+4H₂

The hydrogen and carbon monoxide provide the reducing atmosphere to reduce the iron ore into iron. As seen in FIG. 1, iron ore 9 is added to the top of the Direct Reduced Iron furnace and Direct Reduced Iron 11 is recovered from the bottom of the furnace.

The offgas 5 from the furnace is fed to the combined hydrogen sulfide and carbon dioxide separation system. In this system, carbon dioxide 6 is separated from the offgas containing hydrogen sulfide and can be recovered for reuse, venting or potential resale. The hydrogen sulfide meanwhile is recovered in stream 8 and can be fed into the feed line for the natural gas entering the fired heater. Additional fresh hydrogen sulfide may need to be added to this stream to account for system losses.

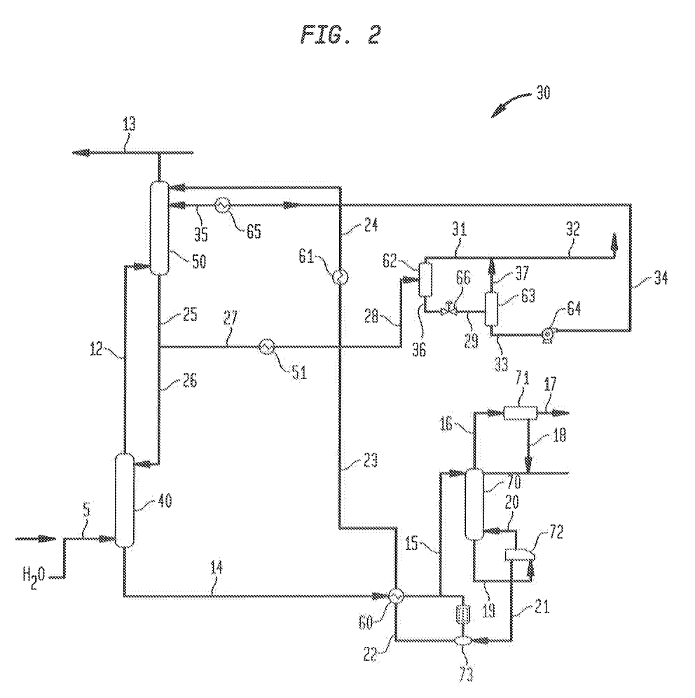

In the current invention, the gas separation device 30 can comprise a carbon dioxide absorber in fluid communication with a hydrogen sulfide absorber which is in fluid communication with a hydrogen sulfide stripper. As shown in FIG. 2, the offgas stream 5 which contains carbon dioxide and hydrogen sulfide is first fed to a hydrogen sulfide absorber 40 to produce a hydrogen sulfide depleted stream 12. The hydrogen sulfide in the offgas stream is absorbed in a circulating liquid which will contain an absorbent material from the family of amine compounds. The hydrogen sulfide enriched liquid 14 is diverted through a heat exchanger 60 and is heated before entering stripper column 70. The liquid passes down the stripper column 70 and exits the bottom of the stripper in stream 19. This stream enters reboiler 72 where it is heated to create a vapor stream 20 which is introduced into the bottom of the stripper column 70. This gas passes up the column and strip hydrogen sulfide from the amine solution. The hydrogen sulfide rich vapor stream 16 exits stripper column 70 and consists mostly of hydrogen sulfide, water, and trace amounts of amine. Stream 16 enters condenser 71 to produce a condensed liquid stream 18 which is returned to stripper column 70. The hydrogen sulfide stream 17 that is recovered can be fed to the natural gas feed line discussed above with respect to FIG. 1 for entry into Direct Reduced Iron furnace system.

The lean amine liquid stream 21 from reboiler 72 is sent to circulation pump 73 to produce pressurized liquid stream 22 which transmits heat to stream 14 in heat exchanger 60, Stream 23 is cooled in heat exchanger 61 against an external cooling liquid such as cooling water to produce pressurized cooled liquid stream 24. The cooled lean amine stream is sent to the top of carbon dioxide absorber 50.

The hydrogen sulfide depleted stream 12 leaving the hydrogen sulfide absorber is fed to a carbon dioxide absorber 50. The carbon dioxide depleted offgas will leave the top of the carbon dioxide absorber in stream 13 and be recycled for use as a feed or a fuel in the process gas heater as necessary.

Like the hydrogen sulfide absorber, the carbon dioxide absorber 50 contacts the offgas with liquid amine streams 24 and 35 that will absorb carbon dioxide. Typical carbon dioxide absorbent materials are from the family of amine compounds. The carbon dioxide enriched amine solution 25 is split into two parts. The first part 26 is sent to the hydrogen sulfide absorber 40 as described previously. The second part 27 is sent to heater 51 to produce heated CO₂ rich stream 28. Stream 28 enters flash separator 62 which produces CO₂ rich gas 31 and amine stream 36 with reduced CO₂ content. Stream 36 is reduced in pressure across valve 66 and is sent to separator 63. Separator 63 produces CO₂ stream 37. This stream is mixed with stream 31 to produce CO₂ stream 32 for use in other unit operations in the plant or for resale outside of the plant. Separator 63 also produces lean amine stream 33. Stream 33 is sent to pump 64 to produce pressurized lean amine stream 34. Stream 34 is sent to cooler 65 where it is cooled against an external cooling liquid such as cooling water to produce cooled stream 35. Stream 35 is fed to CO₂ absorber column 50,

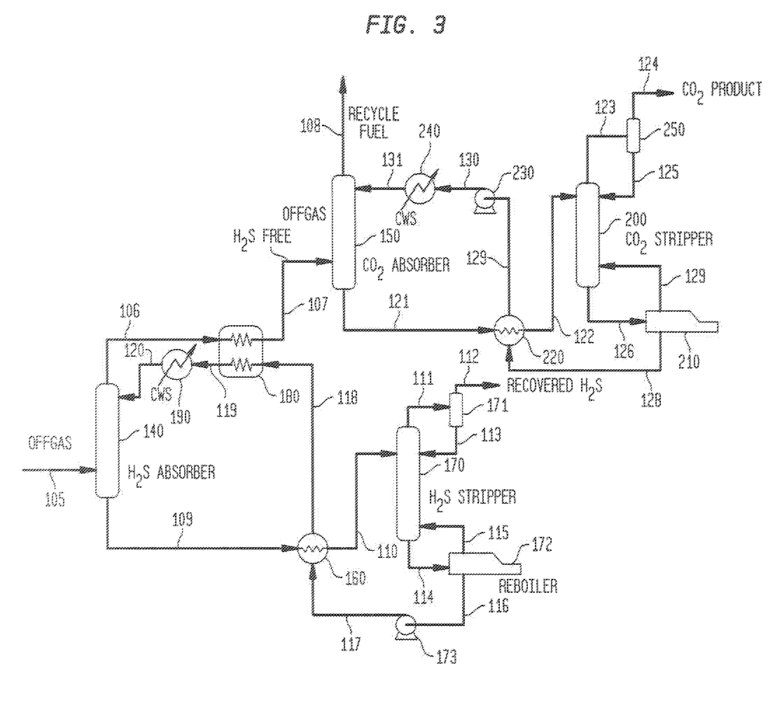

FIG. 3 provides a second embodiment of this technology. The offgas stream 105 containing carbon dioxide and hydrogen sulfide is fed to a hydrogen sulfide absorber column 140 in which the offgas comes in contact with an amine solution. The amine solution absorbs the hydrogen sulfide and produces hydrogen sulfide depleted stream 106. The hydrogen sulfide enriched amine solution 109 is diverted through heat exchanger 160 to produce heated stream 110. Stream 110 is fed to hydrogen sulfide stripper 170 where it passes down the column and exits the bottom of the stripper to form stream 114. Stream 114 enters reboiler 172 where it is heated to create a vapor stream 115 which is introduced into the bottom of stripper column 170. The gas passes up the column and strips hydrogen sulfide from the amine solution. The hydrogen sulfide rich vapor stream 111 exits stripper column 170 and consists mostly of hydrogen sulfide, water, and trace amounts of amine. Stream 111 enters condenser 171 to produce a condensed liquid stream 113 which is retuned to stripper column 170. The hydrogen sulfide stream 112 that is recovered can be fed into the natural gas feed line as discussed above with respect to FIG. 1 for entry into Direct Reduced Iron furnace system.

The lean amine liquid stream 116 from reboiler 172 is sent to circulation pump 173 to produce pressurized liquid stream 117 which transmits heat to stream 109 in heat exchanger 160. Stream 118 is cooled in heat exchanger 180 and further cooled in exchanger 190 against an external cooling liquid such as cooling water to produce pressurized cooled liquid stream 120 which is sent to the top of hydrogen sulfide absorber 140.

The non-absorbed portion of the offgas 106 which contains carbon dioxide will exit the top of the hydrogen sulfide absorber column 140 and is fed to heat exchanger 180 where it is heated up and sent to the carbon dioxide absorber 150.

The carbon dioxide absorber 150 contacts the offgas with a liquid amine stream 131 that will absorb carbon dioxide. Typical carbon dioxide absorbent materials are from the family of amine compounds and can be selected from the group consisting of monoethanolamine, diethanolamine, methyldiethanolamine, diglycolamine, and piperazine. The carbon dioxide enriched liquid amine solution 121 is fed through heat exchanger 220 to stripper column 200. The liquid passes down the stripper column 200 and exits the bottom of the stripper in stream 126. This stream enters reboiler 210 where it is heated to create vapor stream 127 which is introduced into the bottom of the stripper column 200. This gas passes up the column and strips carbon dioxide from the amine solution. The carbon dioxide rich vapor stream 123 exits the stripper column 200 and consists mostly of carbon dioxide, water, and trace amounts of amine. Stream 123 enters condenser 250 to produce a condensed liquid stream 125 which is returned to stripper column 200. The carbon dioxide stream 124 that is recovered can be sold as a byproduct.

The lean amine liquid stream 128 from reboiler 210 is sent to heat exchanger 220 where it is partially cooled against stream 121 to produce partially cooled lean amine stream 129. Stream 129 is fed to circulation pump 230 to produce pressurized lean amine stream 130. Stream 130 is cooled in heat exchanger 240 against an external cooling liquid such as cooling water to produce pressurized cooled liquid stream 131 which is sent to the top of carbon dioxide absorber 150.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the present invention.

Having thus described the invention, what we claim is:

1. A method for operating a direct reduced iron furnace wherein synthesis gas and hydrogen sulfide are fed to the direct reduced iron furnace, the improvement comprising separating carbon dioxide and hydrogen sulfide from offgas from the direct reduced iron furnace.

2. The method as claimed in claim 1 wherein the carbon dioxide and the hydrogen sulfide are recovered.

3. The method as claimed in claim 2 wherein the recovered hydrogen sulfide is fed along with natural gas into a process gas heater.

4. The method as claimed in claim 1 wherein the offgas is fed to a carbon dioxide separation device and a hydrogen sulfide separation device.

5. The method as claimed in claim 1 wherein the carbon dioxide and hydrogen sulfide are separated from the offgas by a carbon dioxide absorber in fluid communication with a hydrogen sulfide absorber.

6. The method as claimed in claim 4 wherein the hydrogen sulfide absorber contains an absorbent material comprising an amine compound.

7. The method as claimed in claim 4 wherein the carbon dioxide absorber contains an absorbent material comprising an amine compound.

8. The method as claimed in claim 5 further comprising a hydrogen sulfide stripper in fluid communication with the hydrogen sulfide absorber.

9. A method for separating hydrogen sulfide and carbon dioxide from offgas from a direct reduced iron furnace comprising feeding the offgas to a separation device.

10. The method as claimed in claim 9 wherein the separation device comprises a carbon dioxide separation device and a hydrogen sulfide separation device.

11. The method as claimed in claim 9 wherein the carbon dioxide separation device is a carbon dioxide absorber and the hydrogen sulfide separation device is a hydrogen sulfide absorber.

12. The method as claimed in claim 9 wherein the carbon dioxide and the hydrogen sulfide are recovered.

13. The method as claimed in claim 9 wherein the recovered hydrogen sulfide is fed along with natural gas into a process gas heater.

14. The method as claimed in claim 10 wherein the carbon dioxide separation device and the hydrogen sulfide separation device are in fluid communication with each other.

15. The method as claimed in claim 11 wherein the hydrogen sulfide absorber contains an absorbent material comprising an amine compound.

16. The method as claimed in claim 11 wherein the carbon dioxide absorber contains an absorbent material comprising an amine compound.

17. The method as claimed in claim 15 further comprising a hydrogen sulfide stripper in fluid communication with the hydrogen sulfide absorber.

18. A method for recycling hydrogen sulfide from a direct reduced iron furnace comprising the steps of: a) recovering offgas comprising carbon dioxide and hydrogen sulfide from the direct reduced iron furnace; b) separating the carbon dioxide from the hydrogen sulfide; and c) feeding the hydrogen sulfide to the direct reduced iron furnace.

19. The method as claimed in claim 18 wherein the offgas is fed to a carbon dioxide separation device and a hydrogen sulfide separation device.

20. The method as claimed in claim 19 wherein the carbon dioxide separation device is a carbon dioxide absorber and the hydrogen sulfide separation devices is a hydrogen sulfide absorber.

21. The method as claimed in claim 20 wherein the carbon dioxide absorber is in fluid communication with the hydrogen sulfide absorber.

22. The method as claimed in claim 20 wherein the hydrogen sulfide absorber contains an absorbent material comprising an amine compound.

23. The method as claimed in claim 20 wherein the carbon dioxide absorber contains an absorbent material comprising an amine compound.

24. The method as claimed in claim 20 further comprising a hydrogen sulfide stripper in fluid communication with the hydrogen sulfide absorber.
